(19) United States
(12) Patent Application Publication
(10) Pub. No.: US 2004/0022914 A1
(43) Pub. Date: Feb. 5, 2004

(54) Novel sweetener compositions and methods of use

(76) Inventor: Ann de Wees Allen, St. Petersburg, FL (US)

Correspondence Address: SALIWANCHIK LLOYD & SALIWANCHIK, A PROFESSIONAL ASSOCIATION, 2421 N.W. 41ST STREET, SUITE A-1, GAINESVILLE, FL, 326066669

(21) Appl. No.: 10/458,125

(22) Filed: Jun. 9, 2003

Related U.S. Application Data
(60) Provisional application No. 60/387,095, filed on Jun. 7, 2002.

(51) Int. Cl. A23L 1/236

(52) U.S. Cl. 426/548

(57) ABSTRACT

The subject invention provides natural low glycemic sweeteners that are palatable and do not contain high glycemic, insulin-stimulating ingredients. In one embodiment, the subject invention provides a novel nutritive-sweetener/carbohydrate comprising kiwi fruit, a glycoside and a carbohydrate. Preferably, the glycoside is a fruit glycoside and the carbohydrate is fructose. In another embodiment, the subject invention provides a novel sweetener/carbohydrate composition comprising caffeine, chromium, and TRUTINA DULCEM. The sweetener/carbohydrate compositions of the subject invention are acceptable for use by persons desiring to avoid high glycemic, insulin-stimulating sugars and sweeteners. More specifically, these compositions are acceptable for use by diabetics and hypoglycemics.

### CROSS-REFERENCE TO A RELATED APPLICATION

This application claims the benefit of provisional patent application Serial No. 60/387,095, filed Jun. 7, 2002, which is hereby incorporated by reference in its entirety.

### BACKGROUND OF THE INVENTION

The problem of weight control, in particular minimization of the accumulation of fat, has long been an issue of concern for people. Conventional dieting employing caloric restriction has been shown to be inconsistent, at best, for weight control. When receiving insufficient calories, the human body experiences fatigue, immune suppression, increased fat cell storage, and depression. In addition, statistics have shown that 95% of all persons who diet gain back most of the lost weight within one year.

The urge to eat is rooted in the brain's genetic-survival program and cannot be ignored. Successful weight control depends on four important factors: sufficient caloric intake; balanced blood sugar levels; proper nutrient intake; and taste satisfaction with the food consumed. If any one of these factors is ignored, weight control is less than optimal.

Obesity is becoming a global epidemic. Obesity is now so common within the world's population that it is beginning to rank with infectious diseases and malnutrition as one of the most significant contributors to ill health. Obesity is associated with diabetes mellitus, certain forms of cancer, sleep-breathing disorders, and coronary heart disease. There remains a long-felt need in the art for a method of weight control that is convenient and yet can maintain its beneficial effects for a long period of time.

Despite the proven medical risks associated with weight gain, the obesity rate continues to grow at an alarming rate. The Center for Disease Control (CDC) reported that the number of people considered obese increased from 12% in 1991 to 17.9% in 1998. According to the New England Journal of Medicine, 58 million people in America are obese.

Factors that play a role in the development of obesity also include insulin growth hormone, lipoprotein lipase (LPL), leptin, ventromedial hypothalamic lesions, endogenous opioid peptides, norepinephrine, epinephrine, serotonin, density of alpha-2 adrenergic receptors, genetics, caloric intake, dietary ratios of protein-to-carbohydrates-to-fat, and exercise. Perhaps the most influential determinate of the fat-storing pathway of consumed food is LPL.

LPL is an enzyme which hydrolyzes plasma triglyceride into free fatty acids (FFA) and glycerol, and works for the uptake of plasma triglyceride by the tissue. Adipose tissue LPL permits uptake of plasma triglyceride as storage in fat cells, while muscle LPL utilizes plasma triglyceride as fuel for muscle. Consequently, adipose tissue LPL is very important for fat accumulation. Insulin increases adipose tissue lipoprotein lipase (LPL) activity, and LPL increases the burning of fat in muscle cells.

There is a direct correlation between plasma LPL activity and insulin levels, but muscle LPL activity is not insulin dependent. In sports nutrition, body builders and other athletes utilizing insulin as a means of increasing muscle mass are actually programming the body to store fat as opposed to building muscle mass.

When high glycemic insulin-stimulating carbohydrates and/or sugars are eaten, the result is stimulation of LPL. This enzyme sends the message to store food in the fat cells. Consequently, ingestion of high glycemic foods can result in accumulation of excess adipose tissue (body fat). High glycemic foods are the least abundant foods found in the natural human food chain. Conversely, recently, high glycemic foods have become the most abundant form of food.

Since many Americans are either overweight or obese, it is inevitable that a large percentage of the population will eventually develop diabetes. With dietary intervention, this can be prevented. Insulin is stimulated by ingestion of high glycemic foods and drinks. Low glycemic foods are converted into glucose more slowly than high glycemic foods, so the lower the glycemic index of the food, the less insulin is required to control blood sugar. In order to control insulin elevated by dietary factors, the glycemic response of all foods and drink needs to be factored into the dietary equation.

Various sweeteners are known in the art. Monosaccharides, the simplest carbohydrates, are aldehydes or ketones having two or more hydroxyl groups, having the empirical formula (CH₂O)ₙ. Monosaccharides having an aldehyde functional group are known as aldoses while those having a ketone functional group are ketoses. A sugar having six carbon atoms is called a hexose. Common hexoses include fructose (a ketose) and glucose (an aldose). A disaccharide consists of two sugars joined by an O-glycosidic bond. Three highly abundant disaccharides are sucrose, lactose, and maltose. Sucrose (common table sugar) is obtained from cane or bees.

Until the proliferation of artificial chemical sweeteners, sucrose and honey were the most commonly used sweeteners. These sugars, however, cause an imbalance in insulin levels, thereby causing energy and mood swings, and stimulating cravings for sweets. As compared to other sweeteners, sugar and honey not only increase the urge for more sweets and carbohydrates, but also stimulate the pancreas to secrete large amounts of insulin.

Because of the fat-storage effects of sucrose and honey, many food manufacturers concerned with health have switched to glucose and glucose polymers. Glucose is a crystalline sugar also found in fruits and honey. However, glucose also causes the release of a large amount of insulin.

A low glycemic carbohydrate/sweetener that does not stimulate an increase in the size of the fat-cell would provide benefit to overweight persons, as well as to diabetics.

The Glycemic Index. Glycemic researchers rank carbohydrates and sugars according to their ability to break down into glucose and enter the bloodstream, thus triggering insulin to be released. This ranking system is called the “glycemic index.” The glycemic reaction of mixed meals, prepared foods, packaged foods, or foods containing multiple ingredients is called the “glycemic response.”

When carbohydrates, including sugars, are ingested in humans they are converted into glucose. In response to the glucose entering the bloodstream, the pancreas releases insulin. The insulin then transports the glucose-sugar into muscle cells and the liver for later use as an energy fuel. Certain carbohydrates, namely high glycemic carbohydrates, break down very rapidly in the digestive tract, sending an excess amount of glucose into the bloodstream. When that happens, the pancreas responds by sending out large amounts of insulin to handle the load.

All sugars, carbohydrates, and foods have a glycemic response in the body. Glucose has a glycemic index of 100, which creates a significant rise in blood sugar and insulin. Dextrose, maltodextrins, sucrose (table sugar), honey, high fructose corn syrup, and many other carbohydrates and sugars are commonly used in foods and drinks. These sugars/carbohydrates are also high glycemic and can cause the following negative responses in the body:

Elevation of blood sugar

Elevation of insulin

Increased risk of diabetes

Stimulation of fat-storage and size of fat cells

The average American's diet contains an abundance of high glycemic foods. Consistent consumption of high glycemic foods causes an excess of insulin levels in the body. Excess insulin exacerbates insulin resistance. It is currently estimated that one-fourth of all Americans are insulin-resistant. Insulin resistance causes muscle cells to lose sensitivity to insulin, thus requiring higher and higher amounts of insulin to be released in order to meet the demands of the incoming glucose.

When the pancreas is able to keep up with the demand, insulin resistant persons stay in relative balance, with weight gain and lethargy as a side effect. When the pancreas cannot cope with the strain, blood glucose abnormalities are often a result. It is important for persons with blood sugar imbalances to pre-determine the glycemic response of a food, meal, sugar or sweetener prior to consuming it.

Muscle Glycogen. Carbohydrates that are stored in the body's muscle tissue are referred to as muscle glycogen. Muscle glycogen is essential in sports performance, endurance, and the conversion of fat to energy. The more muscle glycogen available during sustained exercise, the greater the potential for improved endurance. Sustained exercise requires available muscle glycogen.

Different sugars have different effects on muscle glycogen depletion rates. Glucose and other high glycemic sugars and carbohydrates like maltodextrins, provide a quick spurt of energy. This triggers the release of insulin and increases the depletion of muscle glycogen. This negative biochemical chain reaction also suppresses the conversion of fat to energy, which can cause an athlete to “hit the wall.” In the average person it causes stimulation of fat-storage, increased size of fat cells, weight gain, lack of energy, blood sugar swings and exacerbation of development of diabetes and other blood sugar disorders.

Unlike high glycemic sugars and carbohydrates, low glycemic sugars and carbohydrates do not cause a rapid rise in either blood sugar or insulin. Low glycemic carbohydrates/sugars help energy stores in the muscles last longer, thus increasing the potential for greater endurance during exercise. Low glycemic sports drinks taken prior to exercise result in a much lower rate of muscle glycogen depletion. Sports drinks and drinks made with high glycemic carbohydrates and/or sugars can reduce sports performance. Low glycemic sugars/carbohydrates can be used in place of high glycemic sugars to help alleviate muscle glycogen impairment during athletic events.

Glycosides. Glycosides are sugar derivatives providing intense sweet taste, and in some cases, a bitter taste. Glycosides are water soluble compounds which can be found in certain plants, legumes, Chinese teas, and fruit. Glycosides are broken down into sugars (including glucose) by enzymes. A “glucoside” is a glycoside that yields glucose.

Glycosides contain a carbohydrate portion (glycone) and a non-carbohydrate portion (aglycone). Based upon the chemical nature of the aglycone portion, glycosides can be placed into the following twelve basic categories:

Glycoside Classifications:

Tannins

Cardioactives

Aldehydes

Anthraquinones

Alcohols

Saponins

Lactones

Cyanophores

Isothiocyanates

Phenols

Flavonals

Natural sweet glycosides range in sweetness up to 425 times sweeter than sucrose, with a molecular weight of 250 to 1000.

Kiwi Fruit. Classified as a subtropical fruit, kiwi grows on a woody, twining vine or climbing shrub that can reach 30 feet. The history of the kiwi fruit began in the Chang Kiang Valley of China. Called Yang Tao, it was considered a delicacy by the great Khans who relished the fruit's brilliant flavor and emerald-green color. Knowledge of the fruit expanded to other countries in the mid 1800s to 1900s. A collector for the Royal Horticultural Society of Britain sent samples home in 1847, and another sent seeds to England in 1900.

Plants were first exported from China to the United States in 1904, and seeds were brought to New Zealand in 1906. Kiwi fruit is available worldwide today and is produced in New Zealand, the United States, Italy, Japan, France, Greece, Spain, Australia, and Chile. By 1984, kiwi groves in California totaled 6,000 acres.

There is no known toxicity related to kiwi fruit, and it is considered to be a beneficial fruit. In clinical studies, kiwi fruit has been shown to limit symptoms of asthma and other respiratory disorders. In a study of 18,737 children, a higher intake of kiwi fruit and vitamin-C rich citrus fruit diminished shortness of breath, chronic and nocturnal cough, non-coryzal rhinitis, and wheezing (Thorax [April 2000] 55(4):283-288).

According to the U.S. Food and Drug Administration, Center for Food Safety and Applied Nutrition, SN/AEMS report on adverse health problems reported to the FDA, related to foods, food ingredients, and nutrients, there is no report of any negative health effect associated with or directly related to ingestion of kiwi.

Despite its safety profile, kiwi fruit has been typically eliminated from being used in any sweetener formula or product due to its conflicting enzymatic activity when in contact with yogurt, yogurt cultures, frozen yogurt, and any product containing yogurt, yogurt cultures, or yogurt enzymes.

“Kiwi fruit cannot be blended with yogurt because an enzyme conflicts with the yogurt process” (Department of Horticulture, Purdue University, January 2001; page 10; Morton, J. [1987] Kiwifruit, pp 293-300).

Many common grocery store food products currently contain yogurt and yogurt by-products and cultures. Many nutraceutical products also contain yogurt and yogurt by-products. A sweetener that could not be used in, near, or with these products would find an extremely limited market.

### BRIEF SUMMARY OF THE INVENTION

The subject invention provides natural low glycemic sweeteners that are palatable and do not contain high glycemic, insulin-stimulating ingredients. Advantageously, the compositions of the present invention do not stimulate lipoprotein lipase (LPL) in humans, and provide an alternative to chemical sweeteners.

In one embodiment, the subject invention provides a novel nutritive-sweetener/carbohydrate comprising kiwi fruit, a glycoside and a carbohydrate. Preferably, the glycoside is a fruit glycoside and the carbohydrate is fructose. In a preferred embodiment, the primary sweetening agents of the composition of the subject invention are natural fruit glycosides. Polysaccharides from kiwi provide a secondary component and ketohexose monosaccharides from fruit sugar provide a tertiary component. In a specific embodiment, the kiwi is powdered kiwi.

In another embodiment, the subject invention concerns a composition comprising caffeine, chromium, and TRUTINA DULCEM. Preferably, the composition comprises about 30 mg to about 150 mg of caffeine, about 5 mcg to about 500 mcg of chromium, and about 2 g to about 20 g of TRUTINA DULCEM. Optionally, the composition can further comprise fructose (e.g., about 2 g to about 20 g), thus comprising caffeine, chromium, TRUTINA DULCEM, and fructose. Alternatively, fructose can be used as a substitute for the TRUTINA DULCEM, thus comprising caffeine, chromium, and fructose.

The sweetener/carbohydrate compositions of the subject invention are acceptable for use by persons desiring to avoid high glycemic, insulin-stimulating sugars and sweeteners. More specifically, these compositions are acceptable for use by diabetics and hypoglycemics. Furthermore, these sweetener/carbohydrate compositions are acceptable for use by dieters and can also be used by athletes to help prevent muscle glycogen depletion. These compositions do not reduce sports performance, and to the contrary, they increase the potential for greater endurance during exercise.

Advantageously, the sweetener/carbohydrate compositions described herein do not stimulate resisten. In individuals with Type 2 diabetes, the compositions of the present invention decrease the glucose and insulin responses to the oral Glucose Tolerance Test (OGTT). In normal humans, especially those with the poorest glucose tolerance, the present invention improves glucose tolerance.

### DETAILED DISCLOSURE OF THE INVENTION

The subject invention provides natural, low glycemic, low calorie, nutritive carbohydrate sweetening compositions. The natural sweetener of the subject invention comprises kiwi, at least one glycoside and at least one carbohydrate.

The sweetener compositions of the subject invention are particularly advantageous because they do not significantly stimulate lipoprotein lipase (LPL), the fat-storing enzyme. In a preferred embodiment the subject invention provides compositions comprising kiwi fruit, fruit glycosides, and fruit sugar. Specifically exemplified herein are a sweet crystalline powder sweeteners which are pleasing in taste, mouth-feel, and other organoleptic qualities without the use of artificial sweeteners or sucrose or any other high glycemic sugar/sweetener.

In a preferred embodiment, the present invention provides novel compositions which are orally administered and which can be used for preventing or treating excess weight gain, e.g., obesity.

In another embodiment, the subject invention concerns a composition comprising caffeine, chromium, and trutina dulcem. Preferably, the composition comprises about 30 mg to about 150 mg of caffeine, about 5 mcg to about 500 mcg of chromium, and about 2 g to about 20 g of trutina dulcem. Optionally, the composition can further comprise fructose (e.g., about 2 g to about 20 g). Alternatively, fructose can be used as a substitute for the trutina dulcem. Compositions for the prevention or treatment of weight gain comprising caffeine, chromium, and fructose, have been described previously in U.S. Pat. No. 5,480,657, which is incorporated herein by reference, including all figures and tables.

TRUTINA DULCEM (TD) is a natural sweetener typically made from fruit (e.g., kiwi fruit and natural fruit flavors) and low glycemic carbohydrates from fruit sugar. TRUTINA DULCEM does not overly elevate insulin levels and is therefore ideal for most diabetics and hypoglycemics. Unlike sucrose, TD does not stimulate lipoprotein lipase fat-storing enzymes, so it is an excellent agent for the treatment and prevention of weight gain (e.g., excess body fat).

The subject invention further provides methods for manufacturing and using low glycemic sweeteners. In the practice of a preferred method of the subject invention, a natural, low glycemic, low calorie, nutritive carbohydrate sweetening composition is used in place of high glycemic sugars, sweeteners and/or carbohydrates in foods, beverages and other compositions for oral consumption.

Advantageously, the compositions of the present invention comprise compounds that the body synthesizes and metabolizes. Thus, these compositions follow a normal metabolic process in a human or animal. Though the caloric content of the present invention is low, the metabolic process remains the same as any low gylcemic natural fruit, such as peaches, pears, apples, and oranges. The present invention is re-sorbed more slowly than glucose; it is more slowly absorbed by facilitated diffusion from the gastrointestinal tract than glucose.

Everything which animals eat has an effect on blood sugar. Foods which overly elevate blood sugar levels trigger an over-secretion of insulin, and insulin is a precursor of lipogenesis (fat storage). Aside from promoting fat storage, insulin peaks also cause low blood sugar which can set off eating binges. Thus, the low glycemic food compositions of the subject invention, which do not elevate blood sugar levels, are desirable for weight control and for maintenance of good health.

In addition to providing a broad range of health benefits, the compositions of the present invention can also be used to control appetite. False cravings for food are most often caused by low blood sugar. Humans need to eat every three hours to keep blood sugar levels properly balanced. Blood sugar levels account for energy as well as level of mental function. In the past, humans consumed small portions of food throughout the day. As a result, the human body continues to function more efficiently when fed every few hours. When one does not eat frequently enough, the result is tiredness, weakness, inability to focus and, as a result of improper eating habits, weight gain eventually results. In our busy society, eating every few hours, however, is not possible. The composition of the present invention thus provides carbohydrates needed by the body to stop the blood sugar from plunging.

Unlike most sweeteners, the compositions of the present invention have little effect on blood sugar levels, as the liver converts the composition to glucose over a period of time. Advantageously, the compositions of the present invention act, metabolically, like a time-release carbohydrate, thus eliminating insulin-spillover. This provides a preferred sweetener for diabetics and hypoglycemics. The compositions described herein may also be used as a diet aid due to these factors. The novel compositions are also less cariogenic than sucrose.

Obese individuals (who do not have diabetes) typically have normal blood sugar levels and elevated insulin levels (in fasting and fed states). Obesity causes certain tissues in the body to be less sensitive to insulin, and this insulin resistance is one of the main features of type II diabetes. Continual high insulin levels lead to diabetes. Continual high insulin levels can lead to diabetes.

The compositions of the present invention may be used in diabetic formulations including meal replacement drinks and bars, medical feeding formulas, diabetic candies, and products for diabetic children. The compositions of the subject invention can be used in chewable formulations, such as chewing gums and chewable tablets. The compositions of the present invention can be used in the dietary management of blood sugar levels, since substitution of these low glycemic sweeteners for other simple carbohydrates reduces post-prandial glucose levels which aids in overall control.

A protein-hormone produced by fat cells (adipocytes), called resisten, has been identified as providing a link between diabetes and obesity (Flier, Jeffrey S. [2001] “Diabetes: The Missing Link with Obesity?” Nature 409:292-293). Resisten suppresses insulin's ability to stimulate glucose uptake into adipose fat cells. Insulin-stimulated glucose uptake by adipocytes is enhanced by neutralization of resisten and is reduced by resisten treatment (Steppan et al. [2001] “The hormone resisten links obesity to diabetes” Nature 409:307-312).

In a preferred embodiment, the compositions of the subject invention can be used to diminish the concentration and/or effects of resistin. This neutralization of resistin activity reduces the proclivity towards, and/or effects of, Type II diabetes and helps to control and/or prevent obesity.

In a specific embodiment, the present invention provides a natural sweetening composition comprising: (a) kiwi fruit, (b) at least one natural fruit glycoside, and (c) at least one low glycemic carbohydrate from fruit. The compositions of the present invention are natural sweeteners to be used in place of high glycemic sugars, sweeteners and/or carbohydrates.

In a preferred embodiment, the subject invention combines several unique factors including:

a) Use of acid glycosides;

b) Combining the acidic properties of specific glycosides with the buffering-effect of fruit sugar;

c) Utilization of small amounts of kiwi fruit (less than 1 gram per serving); and

d) Using either powdered kiwi fruit or fresh fruit extracts.

The various components of the composition of the subject invention are discussed in more detail below.

Kiwi Component

The kiwi flavor is subacid to quite acid, which advantageously matches well with glycosides used according to the present invention. The fruit's special sweetness with a delicate citrus character and a hint of strawberry and pineapple also provides flavor and sweetener characteristics to the present invention.

Chinese kiwi fruit is preferred in the practice of the present invention. New Zealand kiwi fruit is the second choice, and California kiwi fruit, the third choice. There are four main Chinese classes of kiwi fruit:

Zhong Hua

Jing Li

Ruan Zoa

Mao Hua

The polysaccharides in kiwi fruit are categorized as carbohydrates and are one of a group of carbohydrates that upon hydrolysis yield more than two molecules of simple sugars. They are complex carbohydrates of high molecular weight, usually insoluble in water, but when soluble, they form colloidal solutions. They include two groups: starch and cellulose. The hemicelluloses include the pentosans (e.g. gum Arabic), hexosans (e.g. agar-agar), and hexopentosans (e.g., pectin).

The present invention overcomes the significant problems associated with using kiwi fruit in a sweetener/carbohydrate product. The sweetener compositions described herein have none of the negative side-effects typically associated with kiwi and kiwi products. Advantageously, these compositions can be used in conjunction with yogurt and yogurt by-products without any conflicting enzymatic activity.

Glycoside Component

Preferably, the compositions of the present invention contain glycosides from fruit. In a preferred embodiment, the sweetener compositions of the present invention comprise triterpene and/or other terpene glycosides as preferred, non-toxic glycosides. Particularly preferred glycosides include the following:

Sweet Diterpenoid Glycosides Compounds

ent-Kaurene type

Dulcoside A, Rebaudioside A-E, Stevioside, Rubusoside, Suavioside A, B, G, H, I, J, and Steviol 13-O-O-D-glucoside (or Steviolmonoside)

Labdane type

Baiyunoside, Gaudichaudioside A, and Phlomisoside-I

Sweet Triterpenoid Glycosides Compounds

Cycloartane glycosides type

Abrusosides A-D

Oleanane glycosides type

Glycyrrhizin, Apioglycyrrhizin, Araboglycyrrhizin, and Periandrin I-V (these are toxic)

Cucurbitane glycosides type

Siamenoside I, Mogroside W, V, and 11-Oxomogroside V

Secodammarane glycosides type

Pterocaryosides A, B

Dammarane

Gypenoside XX

These natural sweet triterpene and terpene glycoside compounds can be extracted from roots, leaves, plants, legumes, and fruit.

Compounds of sweet triterpenoid glycosides are based on five distinct triterpene carbon skeletons, and accordingly divided into five types as listed above. Some of these triterpene glycosides, for example a number of dammarane and oleanane types triterpenoid glycosides, are “antisweet” or “sweetness-enhancing” as determined by their sweetness-inhibitory/enhancing (or sweetness-modifying) properties.

Several sweet terpene glycosides are extensively used as flavoring agents. A labdane diterpene arabinoside (gaudichaudioside A) was found to exhibit sweet properties, unlike most glycosides from species in the same genus. However, for purposes of the present invention, arabinosides are not preferred. These sweet terpenes include:

Phyllodulcin

Glycyrrhizin

Rebaudioside A

Stevioside

Thaumatin

Methods for obtaining glycosides from fruit are well known in the art and are described in, for example, U.S. Pat. Nos. 5,411,755; 4,084,010; 6,103,240; and 6,124,442. These methods generally include one or more extraction and/or concentration steps.

As a further component, or as a substitute for a naturally occurring glycoside, the sweetener of the subject invention can optionally include one or more semi-synthetic or wholly synthetic glycoside analogs. Examples of such glycoside analogs include, but are not limited to, modified ent-kaurene diterpenoid glycosides, modified labdane diterpenoid glycosides, modified cycloartane triterpenoid glycosides, and modified oleanane triterpene glycosides. An analog of rebaudioside A has been synthesized, having (sodiosulfo)propyl group at C-19 in place of the 10-O-P-D-glucosyl moiety of the natural product (Dubois, G. E. et al. [1984] J. Agric. Food Chem. 32:1321-1325). This semi-synthetic compound exhibited a sweetness quality superior to that of sodium cyclamate and close to aspartame, without any concomitant bitterness. Numerous studies on stevioside and rubososide have been performed in which sugar moieties (in particular that of C-19) have been modified by enzymatic transglucosylation (Tanaka, 0. [1997] Pure Appl Chem. 69:675-683). A number of general approaches to enzymatic sweetener modification have been developed, including trans-α-1,4-glucosylation using a cyclomatlodextringlucanotransferase (CGTase)-starch system (Tanaka O., 1997). Sugar residues of varying chain length, including glucose, rhamnose, and xylose have been introduced by the silver nitrate/tetramethylurea (AgOTf/TMU) method into (+)-baiyunol, the racemic form of the aglycone of the sweet compound baiyunoside. The cycloartane-type triterpenoid abrusoside has been monomethylated at the glucuronic acid moiety by refluxing with MeOH and HCl, producing a compound with 150 times the sweetness potency of sucrose (Yamada, H. and Nishizawa, M. [1992] Tetrahedron, 48:3021-3044; Nishizawa, M. and Yamada, H., [1995] Synlett, 785-793). The saccharide portion of the sweet oleanane-type triterpenoid glycyrrhisin has been modified, as well. For example, the monoglucuronide of glycyrrhizin has been produced from the parent compound by enzymatic hydrolysis, and was found to be more than 941 times sweeter than sucrose.

Carbohydrate Component

In a preferred embodiment, the carbohydrate component is a fruit sugar. Fructose is commonly called “fruit sugar” because of its widespread occurrence in fruits. Fructose may exist as either of two stereoisomers, designated as either D-fructose or L-fructose. The L-fructose form is preferred in the practice of the present invention. L-fructose is a ketohexose and its molecular formula is C₆H₁₂O₆.

Fructose supplies relatively consistent energy levels with minimal or no stimulation of insulin production. Sugar (sucrose), honey, glucose and many common carbohydrates supply energy but they also stimulate insulin production. This causes rebound tiredness and fat gains. By contrast, fructose which is used in the present composition remains in the intestinal tract for a longer period of time than regular sugars or carbohydrates. This provides for a type of time-released energy and therefore relatively consistent levels of energy production result.

The amount of fructose in the composition of the present invention is an effective amount to achieve the desired effect of the present invention, i.e., to work along with the other components present in the composition in order to provide a sweetener with a low glycemic index. The amount of sugar generally ranges from about 2 to 20 grams per serving, preferably about 3 to 12 grams per serving, and more preferably about 5 grams per serving. A serving usually represents about six to twelve ounces.

Fruit sugar is white and odorless, providing the present invention with no interference in terms of flavor. Though fruit sugar (in small amounts) is acceptable in terms of glucose tolerance (GT) and glycemic response, the problem of cohesion of the formula can occur if the fruit sugar has a different mesh size than that of the kiwi fruit and the glycosides.

Blending of Components

In a preferred formulation of the subject invention, the components of the sweetener composition blend completely. If the kiwi fruit powder (or extracts), and the fruit sugar, and the glycosides do not match in mesh size, the formula will not stay in a blended state. This causes part of the mix to be very sweet, while other parts are less sweet, creating an inconsistent sweetener.

Avoidance of Toxicity

Since the present invention is a natural (partially or wholly non-synthetic), nutritive sweetener, the exclusion of toxic and potentially toxic glycosides is essential. Though several of the glycosides are acceptable as sweetening agents, their toxicity, potential toxicity, and side-effects eliminate their inclusion in the present invention.

For example, sweeteners derived from fruits and plant containing glycosides such as Licorice (Glycyrrhiza glabra), and extracts of Licorice, are considered to be medically inappropriate due to their toxicity.

Fruits and other plants produce a number of chemical entities and some of these constituents can be used as drugs of abuse, and are commonly involved in poisoning. Plants containing naturally-occurring hypertensive principles and those with high levels of amine compounds can be antagonistic to antihypertensives. Concurrent use of Aloe juice and/or exudates (commonly used) with Licorice may be potentiated with Aloe.

Toxicity problems have been attributed to the use of the plant Ma-Huang (Ephedra sinica). The present invention, therefore, does not include cardiac glycosides, as associated with Ma Huang and other plant glycosides.

Chart of Toxic Plants and/or Herbs
considered Unsafe or Unfit for Human Use*

| | |
|---|---|
| LICORICE: | Glycyrrhiza glabra |
| Licorice | Glycyrrhizin [glycyrrhizic acid] |
| glycosides: | Potential cardiac arrest and heart failure |
| MA-HUANG: | Ephedra sinica |
| | Illegal in some states. Dysrhythmias occur with cardiac |
| | glycosides. |
| SASSAFRAS: | Sassafras albidium |
| | FDA has prohibited Sassafras as flavors or food |
| | additives |
| POKE ROOT: | Phytolacca Americana |
| Poke Root | Triterpenoid saponins |
| glycosides: | Highly toxic to many organs of the body |

*Partial Chart from The University of Maryland, School of Pharmacy

Uses of the Sweetener

The sweetener composition of the present invention is enhanced by the use of kiwi fruit as a key component and may be used as stand-alone sweeteners, or as food ingredient/materials. The sweetener dissolves thoroughly in hot or cold beverages and may be used in any sweetening application, including baking and cooking.

Unlike many sweeteners currently on the market, baking and cooking (exposure to heat up to 450 degrees for one hour) with the sweeteners of the present invention do not cause a significant reduction in sweetness levels. Persons with intolerance to glucose, sucrose, and other high glycemic sugars, may use these compositions in creating baked goods that do not overly-elevate insulin levels.

In the practice of the present invention, the ingested level of fruit sugar per dose per person has been reduced to about 1 gram (in the table-top version), thus creating a sweetener that can be used by persons with glucose intolerance (GT); i.e. diabetics, hypoglycemics, and persons diagnosed with Syndrome X and insulin-resistance. The use of kiwi fruit and fruit glycosides in the compositions of the present invention elevate the level of sweetness so that fruit sugar can be used in small amounts.

Compared to sucrose, the sweetness level of the sweetener compositions of the present invention, at 15 times sweeter than sucrose, delivers a significant reduction in calories of 221.2 calories, with only a small dose of fruit sugar (less than 1 gram). This reduction in calories meets the guidelines of an intense, low calorie sweetener.

Calories in Sugar and
Sugar Alternatives as Compared to the Present Invention

| Product | Size | Calories |
|---|---|---|
| Equal (aspartame) | 1 pkt | 4 |
| Sugar Twin saccharin | 1 pkt | 4 |
| Sweet 'n Low | 1 pkt | 4 |
| Sweet One | 1 pkt | 4 |
| Weight Watchers Sweet'ner | 1 pkt | 4 |
| Brown Sugar, dark | 1 tsp | 16 |
| Sugar, granulated | 1 tsp | 15 |
| Sugar, granulated (.2 oz) | 1 pkt | 23 |
| Domino granulated sugar | 1 pkt | 16 |
| Sugar cubes (½ inch) | 2 cubes | 19 |
| Turbinado sugar | 1 tbsp | 50 |
| Present Invention | 1 packet (½ g) | 1.9 |
| Present Invention | 2 packets (1 g) | 3.8 |

Comparison of Caloric & Sweetness Values of the Present Invention as
Compared to Sugar and Fruit Sugar

| Sweetener | Sweetness Value | Amount | Calories |
|---|---|---|---|
| Sugar, sucrose, table sugar | Sugar-sweetness | 80 grams/15 teaspoons | 225.0 |
| Fruit Sugar | 1.7 × sweeter than sucrose | 33 grams/8 teaspoons | 132.4 |
| Present Invention | 15 × sweeter than sugar | 1 gram | 3.8 |

Therefore, the compositions of the present invention provide a benefit, in terms of reducing daily calories consumed, and in using very small doses of fruit sugar instead of large doses. The composition is preferably at least 10 times sweeter than sugar. There is a medical practicality, for diabetics and those watching their caloric intake, in using a natural sweetener that displaces 80 grams of sucrose and 33 grams of fruit sugar per gram of sweetener used.

The practice of the present invention includes the following aspects:

1) Formulated products intended to be consumed and ingested, as well as food products not normally intended to be swallowed, like chewing gum.

2) Food materials such as desserts (including puddings), frozen foods, confections, cake and icing mixes, ice cream, baked goods, sauces, yogurt and frozen yogurt, gelatin mixes and products, jellies, peanut butter, batters for cookies, cakes, pies, breads, and pastries, cereals, bottled and canned beverages, pasta and rice premixes, and in any food material application wherein the sweeteners of the present invention is used as an ingredient and/or raw material.

3) Health care products, such as cough drops and cough syrups, diabetic cough syrups, mouthwash and dental products, antacids, and electrolyte preparations.

4) Sugar Substitutes

5) High glycemic carbohydrate substitutes

6) Fruit juice drinks, sports drinks, beverages, colas, electrolyte drinks, meal replacement drinks, flavored beverage dry mixes, carbonated beverages.

7) Protein bars, diabetic bars, low-carbohydrate bars, high-protein bars, energy bars.

8) Industry flavors; replacing high glycemic flavors currently used in the food industry.

The compositions of the subject invention can be incorporated into a variety of formulations, including, for example, chewable formulations, such as chewing gum and chewable tablets. Various methods of making chewable formulations known in the art can be utilized and the compositions of the subject invention can be incorporated therein. Chewable delivery systems are a highly desirable way of delivering readily soluble active ingredients directly from the oral cavity into the stomach. Chewable compositions, such as chewing gum, can include a water insoluble chewable gum base, such as chicle or a substitute therefore, and natural or synthetic elastomeric resins. Chewable delivery systems that can used with the compositions of the subject invention include those disclosed in U.S. Pat. No. 4,879,108, U.S. Pat. No. 4,882,159, and U.S. Pat. No. 4,882,160. These references disclose chewable, semi-solid delivery systems for active ingredients. The delivery systems disclosed in these references are obtained by admixing precoated ingredients with a confectionary material prepared by forming a solution of gelatin, glycerin, sweeteners, and water. Another chewable formulation is disclosed in U.S. Pat. No. 5,928,664, which describes a consumable, gummy delivery system, which includes an elastic, continuous glycerylated gelatin matrix. Any such chewable formulations can incorporate the compositions of the subject invention, with or without further active ingredients. For example, the sweetener composition of the subject invention comprising caffeine, chromium, and trutina dulcem, can readily be made in chewable form.

All patents, patent applications, provisional applications, and publications referred to or cited herein are incorporated by reference in their entirety, including all figures and tables, to the extent they are not inconsistent with the explicit teachings of the specification.

Following are examples which illustrate procedures for practicing the invention. These examples should not be construed as limiting. All percentages are by weight and all solvent mixture proportions are by volume unless otherwise noted.

### EXAMPLE 1

### Specific Formulation

A reduced calorie, nutritive low glycemic crystalline or powdered sweetener that can be blended to provide sweetness levels from the same sweetness of sucrose to 300 times sweeter than sucrose. The sweetening system is preferably selected to provide a composition comprising:

a) from about 0.001% to about 99% of kiwi fruit powder or kiwi fruit extract derived from kiwi fruit;

b) from about 0.001% to about 99% of a flavoring system comprising a naturally derived terpene or triterpene glycoside derived from fruits (such as Lo Han), plants or vegetables, by weight of said sweetener; and

c) from about 0.01% to 99.9% fruit sugar derived from fruits, corn; wherein said flavoring and sweetening system together provide said low glycemic sweetener.

### EXAMPLE 2

### Kiwi Extract

A specific kiwi extract useful as sweetener according to the subject invention has the following characteristics:

Kiwi Extract (Dried Powder) 5%

| Botanical Name of Kiwi: | Actinidia chinesis and Actinidia deliciosa |
|---|---|
| Part Used: | Fruit |
| Major constituents: | Polysaccharides, actinidine |
| Homogeneity: | Completely homogeneous |
| Solvent used for extraction: | Water |
| Solubility: | Water soluble |
| Extract ratio: | 10:1 |
| Calories | 61 per 100 g |
| Total Fat | 0.6% |
| Sodium | 10 mg/Kilo |
| Carbohydrates | 14.5% |
| Fiber | 0 |
| Protein | 0.8% |
| Calcium | 17 mg/Kilo |
| Iron | 1.2 mg/Kilo |
| Vitamin C | 5% |

### EXAMPLE 3

### Glycosides

The most important sweetening component is saponin glycosides wherein the non-sugar component is a triterpene alcohol and the sugar component is glucose. Either sweet diterterpenoid or triterpenoid glycosides compounds may be used as the glycoside component to provide the flavor and sweetness to the present composition, with their sweetness ranging from 50 to 563 times sweeter than sucrose. There are more highly sweet triterpenoids known than any other class of natural product, representing many of the sweetest products known to occur naturally.

### EXAMPLE 4

### Fructose

The characteristics of a particular fructose composition useful according to the subject invention are as follows:

Crystalline and/or Powdered Fructose
1 teaspoon equals 1.5 grams

| Nutrient | Per Gram |
|---|---|
| Calories | 4 calories |
| Calories per Bomb Calorimetry | 3.6 calories |
| Protein | 0 |
| Carbohydrates | 0.9995 |
| Sugars | 0.9995 |
| Other carbohydrates | 0 |

Crystalline Fructose Supplement Facts
1 teaspoon equals 4 grams

| Nutrient | Per Gram |
|---|---|
| Weight | 1 g |
| Calories | 4 |
| Carbohydrate | 1 g |
| Sugars | 1 g |
| Fructose | 1 g |

### EXAMPLE 5

### Nutrient Analysis of Sweetener Composition

When blended to achieve a sweetness level of fifteen times sweeter than sucrose, one “table-top” sweetener of the present invention, has the following nutrient analysis: 1 teaspoon (15×sweeter than sucrose) powder equals 2.5 grams

Nutrients Per Gram

| | |
|---|---|
| Calories | 3.8 |
| Calories from Fat | 0 |
| Total Fat | 0 |
| Total Carbohydrates | 1 g |
| Sugars (low glycemic) | <1 g |
| Protein | 0 |
| Sodium | 0 |
| Potassium | 0 |
| Fiber | 0 |

### EXAMPLE 6

### Preparation and Storage of Sweetener Composition

The glycosides derived from fruit can be blended with fruit sugar and kiwi fruit powder or extracts. The kiwi fruit powder is added to the glycoside/fruit sugar mix and blended (usually in a V-Blender) until all particles are thoroughly incorporated.

The subject invention provides a practical, palatable, commonly usable low glycemic sweeteners.

Preferably, the composition is kept sealed in a dry, humidity controlled atmosphere (relative humidity below 60%). It is also preferable for the composition to be kept away from direct sunlight, and stored in temperatures below 77 degrees F. In geographic areas where the humidity and/or temperature is high, the sweetener composition can be kept in a refrigerator in a tightly sealed container.

### EXAMPLE 7

### Physical Characteristics of Sweetener Composition

| | |
|---|---|
| APPEARANCE: | White, mild odor, crystalline or powdered, similar |
| | appearance to sucrose. |
| TASTE: | Similar to sugar |
| SOLUBILITY: | Very soluble in water; hot or cold. |
| MELTING POINT: | 103-105 C. (217-221 F.) |
| BAKING/COOKING/ | Up to 450 degrees U.S. oven temp, for one hour |
| TEMPERATURE TOLERANCE: | |

### EXAMPLE 8

### Kiwi Profiles

Nutritional Information

| | |
|---|---|
| Calories (Kcal) | 211 |
| Total Carbohydrates (g) | 50 |
| Simple sugars (g) | 38 |
| Complex Sugars (g) | 10.5 |
| Dietary Fiber (g) | 1.3 |
| Protein (g) | 3.6 |
| Fat (g) | 1.3 |

Minerals

| | |
|---|---|
| Calcium (mg) | 165 |
| Iron (mg) | 9.4 |
| Potassium (mg) | 1230 |
| Sodium (mg) | 20 |

Vitamins

| | |
|---|---|
| Vitamin A (U) | 459 |
| Vitamin C (mg) | 304 |
| Niacin (mg) | 0.00 |
| Riboflavin (mg) | 0.00 |
| Thiamine (mg) | 0.00 |

### Specifications

| | | |
|---|---|---|
| Appearance: | Off White Powder | 330-0 |
| Moisture: | <6.0% | |
| Screen Size (Mesh): | 20# | |

Flavor: Good, clean, free of foreign odor, and taste.

### Microbial

| | | |
|---|---|---|
| Aerobic Plate Count (cpm): | <1000 | 331-0 |
| Yeast (cpm): | <100 | 320-0 |
| Mold (cpm): | <10 | 320-0 |

Fruit Solids Content

70% fruit solids by weight.

Recommended Shipping Requirements

Ship at ambient temperature (preferably less than 75° F.).

Recommended Storage Requirements

Store in cool, dry place, and use within two years of shipping date.

70% Kiwi and 30% is Magnesium Hydrate.

B. Kiwi Fruit Profile B

Composition:

| | |
|---|---|
| Crude protein | 0.61% |
| Ash | 19% |
| Soluble carbohydrate | 77.2% |
| Moisture | 3.0% (by difference) |

Microbiological Analysis:

| | |
|---|---|
| APC | 10 cfu/g |
| Yeasts and Molds | 10 cfu/g |
| Coliforms | 10 cfu/g |
| E. coli | neg/g |
| Salmonella | neg/750 g |

Specification (Typical Analysis):

| | |
|---|---|
| Composition | |
| Soluble carbohydrate | 75% minimum |
| Minerals | 20% maximum |
| Moisture | <4% |
| Physical | |
| Foreign Matter | Absent |
| Sediment | A |
| Solubility in water | 100% |
| Microbiological | |
| APC | <10,000/g |
| Y & M | <50/g |
| Coliforms | <1/g |
| E. coli | neg/g |
| Salmonella | neg/25 g |

Applications:

| | |
|---|---|
| Natural flavorings | Health drinks/nutraccuticala |
| Desserts | Intensifying flavors in toppings/whole fruit |
| Ice-cream | Marinades and Sauces |
| Recombined Juices | Sports drinks/foods |
| Formulated drinks | Natural/Organic excipient |

Advantages:

| | | |
|---|---|---|
| Long shelf life | Concentrated flavor | Low viscosity |
| Low allergenicity | No artificial additives | Low/no browning under |
| | | heat |
| Natural label claims | Low/no color | Low glycemic index |

Composition:

| | |
|---|---|
| Crude Protein | 0.61% |
| Ash | 19% |
| Soluble carbohydrate | 77.2% |
| Moisture | 3.0% (by difference) |

Microbiological Analysis:

| | |
|---|---|
| APC | <10 cfu/g |
| Yeasts and Molds | <10 cfu/g |
| Coliforms | <10 cfu/g |
| E. coli | neg./g |
| Salmonella | neg./750 g |

It should be understood that the examples and embodiments described herein are for illustrative purposes only and that various modifications or changes in light thereof will be suggested to persons skilled in the art and are to be included within the spirit and purview of this application and the scope of the appended claims.

I claim:

1. A sweetener composition comprising kiwi fruit, a fruit glycoside, and fruit sugar.

2. The composition, according to claim 1, further comprising caffeine and chromium.

3. The composition, according to claim 1, wherein the kiwi fruit is Chinese kiwi fruit.

4. The composition, according to claim 1, wherein there is less than 1 gram per serving of kiwi fruit.

5. The composition, according to claim 1, wherein the glycoside is a terpene glycoside.

6. The composition, according to claim 1, wherein the glycoside is a diterpene or a triterpene.

7. The composition, according to claim 1, wherein the glycoside is selected from the group consisting of the following glycoside types; ent-Kaurene; Labdane; Cycloartane; Oleanane; Cucurbitane; Secodammarane; and Dammarane.

8. The composition, according to claim 1, wherein the glycoside is selected from the group consisting of Phyllodulcin; Glycyrrhizin; Rebaudioside A; Stevioside; and Thaumatin.

9. The composition, according to claim 1, which is at least 10 times sweeter than sugar.

10. A method for sweetening a composition wherein said method comprises adding to the composition a sweetener comprising kiwi fruit, a fruit glycoside, and fruit sugar.

11. The method, according to claim 10, wherein said sweetener further comprising caffeine and chromium.

12. The method, according to claim 10, wherein the kiwi fruit is Chinese kiwi fruit.

13. The method, according to claim 10, wherein there is less than 1 gram per serving of kiwi fruit.

14. The method, according to claim 10, wherein the glycoside is a terpene glycoside.

15. The method, according to claim 10, wherein the glycoside is a diterpene or a triterpene.

16. The method, according to claim 10, wherein the glycoside is selected from the group consisting of the following glycoside types: ent-Kaurene; Labdane; Cycloartane; Oleanane; Cucurbitane; Secodammarane; and Dammarane.

17. The method, according to claim 10, wherein the glycoside is selected from the group consisting of Phyllodulcin; Glycyrrhizin; Rebaudioside A; Stevioside; and Thaumatin.

18. The method, according to claim 10, wherein the sweetener is at least 10 times sweeter than sugar.

19. The method, according to claim 10, used to reduce calorie intake compared to the use of sucrose.

20. The method, according to claim 10, wherein said composition is selected from the group consisting of beverages, baked goods, candy and gum.
